(19) United States
(12) Patent Application Publication
(10) Pub. No.: US 2005/0004861 A1
(43) Pub. Date: Jan. 6, 2005

(54) Method of consolidating independent owners of distribution warehouses into a real estate investment trust (REIT)

(75) Inventor: Frederic Speed Bancroft, Monroe, LA (US)

Correspondence Address: Robert L. Waddell;DOMINGUE & WADDELL, PLC, POST OFFICE 3405, Lafayette, LA, 70501, US

(73) Assignee: Bancroft Enterprises, Inc.

(21) Appl. No.: 10/612,630

(22) Filed: Jul. 1, 2003

(51) Int. Cl. G06F 17/60

(52) U.S. Cl. 705/38

(57) ABSTRACT

Methods of consolidating independent owners of distribution warehouses into a Real Estate Investment Trust (REIT) for purposes of achieving economics of scale, for obtaining favorable mortgage financing and for creating a vehicle to enable periodic refinancing and investment of proceeds from such refinancing in real estate opportunities. The REIT is formed and independent owners of distribution warehouses are assembled and selected to participate in the REIT. The participant enters in a sale-leaseback agreement with the REIT and transfers title in their warehouses to the REIT. The REIT finances the purchase of the warehouses by securing a non-recourse loan with at least a seven-year term, serviced on at least a seven-year debt payment schedule. On a periodic basis, preferably every seven years, each warehouse is reappraised, new leases entered into between the REIT and each participant, and new mortgage loans issued for each warehouse. The REIT invests proceeds from the new mortgage loans in real estate opportunities to produce investment revenue. The REIT distributes 90% of net earnings from the investment revenue to the participants.

### FIELD OF THE INVENTION

The present invention relates generally to a method of consolidating independent owners of distribution warehouses into a Real Estate Investment Trust (REIT) for purposes of achieving financial and investment benefits which otherwise would not be available to any one individual warehouse owner, and more particularly for purposes of obtaining economies of scale, including favorable mortgage financing, and for creating a vehicle to enable periodic refinancing and investment of proceeds from the refinancing in real estate opportunities that produce net earnings, 90% of which may be distributed to the REIT's participants.

### BACKGROUND OF THE INVENTION

The Real Estate Investment Trust Act of 1960 propagated laws for the establishment of Real Estate Investment Trusts otherwise known as REITs. A REIT is a company dedicated to owning and operating income producing real estate, such as apartments, shopping centers, and offices. Some REITs finance real estate.

Congress created REITs to permit small investors to make investments in large-scale, income producing real estate. The REIT allowed small investors to pool their investments to acquire large real estate holdings.

When first established, REITs could only own real estate. They could not operate or manage it. This caused REITs to find third-parties to operate and manage the REIT's commercial real estate. But, third-party managers often were viewed as having economic interests diverse from those of the REIT's owners. Investors saw this as a disadvantage. REITs therefore played a limited role in real estate investments until 1986.

In 1986, Congress passed a tax reform act which permitted REITs not only to own income producing commercial properties but to operate and manage them. The law also put an end to real estate tax shelters that had attracted much of the capital from investors, not for the income they produced, but for the losses sustained and passed onto the investors. The change in the law caused real estate investment to focus on producing income.

Under current law, a company can qualify as a REIT if it complies with provisions of the Internal Revenue Code that requires REITs to:
1. be taxable as a corporation;
2. be managed by a board of directors or trustees;
3. have shares that are fully transferable;
4. have a minimum of 100 shareholders;
5. have no more than 50% of the shares held by five or fewer individuals during the last half of each taxable year;
6. invest at least 75% of total assets in real estate assets;
7. derive at least 75% of gross income from rents from real property, or interest on mortgages on real property;
8. have no more than 20% of its assets consist of stocks and taxable REIT subsidiaries; and
9. pay annual shareholder dividends of at least 90% of its taxable income.

REITs are attractive to investors because of their liquidity. Investors can buy and sell interest in diversified portfolios of property simply by buying and selling shares of the REIT. REITs are also considered to be relatively safe and conservative investments because information about the company, its property, the management, and its business plan are usually available, particularly if the REIT is traded publicly. REITs have also shown favorable performance on the stock market.

REITs are classified into three types:
1. equity REITs that own and operate income producing real estate;
2. mortgage REITS that lend money directly to real estate owners and operators or extend credit indirectly through the acquisition of loans or mortgage backed securities; and
3. hybrid REITs which both own property and make loans to real estate owners and operators.

REITs are managed by corporate officers who are accountable to the board of directors as well as the REIT's shareholders and creditors.

U.S. Pat. No. 6,292,788 and U.S. Published Patent Application 0013750 disclose investment methods using REITs by dividing investment real estate into a plurality of tenant-in-common deeds of predetermined denominations that are subject to a master agreement and a master lease to form deedshares. Holders of the deedshares receive an income stream from the master lease without having to manage or maintain the real estate. The master tenant may also purchase the holders' deedshares at the end of a specified term, which further may provide income to the holders.

The method of the present invention differs from prior investment mechanisms involving REITs by providing a unique method of consolidating independent owners of distribution warehouses into a REIT to achieve numerous financial and investment benefits which otherwise would not be available to any one individual warehouse owner.

### SUMMARY OF INVENTION

It is an object of the present invention to monetize the fair market value of a participant's distribution warehouse to create cash reserves that may be used by the participant for working capital and future needs of the distribution company, to strengthen the participant's credit line and that of the distribution company, and to improve the participant's financial condition and the financial condition of the distribution company, as for example, by eliminating debt (and saving interest expense) and by purchasing income producing securities and investments.

It is a further object of the present invention to permit the participant to acquire ownership of the REIT through participation and without the expenditure of money or other compensation for such ownership; neither will the participant be required to guarantee debt of the REIT, lend funds to the REIT, nor assume any direct or contingent liability for ownership of the REIT.

It is a further object of the present invention to provide cash income to the participants through mandatory REIT distributions of at least 90% of net earnings.

It is a further object of the present invention to provide a mechanism through which the REIT acquires income producing real estate and other investment assets by means of periodic re-financing of the distribution warehouses.

It is a further object of the present invention to have the REIT secure non-recourse financing to fund its operations and to acquire income producing assets without pledging the REIT's stock, without pledging a corporate participant's assets or stock, without requiring an individual participant's personal endorsement or guaranty, and without encumbering a participant's line of credit.

It is a further object of the present invention to free the participants from managing the operations of the REIT by instilling such duties in a manager who is supervised by the REIT's Board of Directors.

It is a further object of the present invention to cap the REIT's administrative expenses by dedicating a fixed portion of the rent paid to the REIT for such administrative expenses; in this manner the REIT will never be overburdened with excessive costs or expenses to dilute earnings and such fixed overhead expenses will enhance the price of the REIT's stock if publicly traded.

It is a further object of the present invention to lease the distribution warehouses to the participants after purchase by the REIT at competitive market rates or lower, which is made possible by the unique financing of the REIT and through the consolidation of a large number of warehouses. Low rents offer a savings to the participants that add to their bottom line; for example, a participant with a 60,000 square foot warehouse paying $4.75 per square foot as rent will save $1.00 per square foot, or $60,000 per year, because the REIT is able to offer the warehouse to the participant at $3.75 per square foot.

It is a further object of the present invention to provide a faster amortization rate of financing without a corresponding increase in rent to satisfy the financing's debt service; this results in a shortened period for payment of the debt service and re-mortgaging of the warehouses. The REIT is able to achieve a higher growth rate with increased earnings and a greater payout to the participants. The higher growth rate and earnings will enhance the REIT's stock prices should the REIT be publicly traded.

It is a further object of the present invention to obtain better financing rates and terms with unencumbered collateral, which over time will enhance the REIT's position to negotiate loans at even better rates and terms.

It is a further object of the present invention to grow the REIT by acquiring income producing real estate assets without leveraging these acquired assets; net earnings from the acquired assets will not be burdened with interest and the net income will be available to distribution to the participants of the REIT.

It is a further object of the present invention to establish a unique lessor-lessee relationship unlike the typical situation where the REIT would have to acquire leases on the open market by negotiating with third-party lessees; under the present invention, the REIT and each participant are lessor and lessee, which results in a controlled rent and a controlled stream of rental income which will be unique to the REIT vis-a-vis all other REITs. This controlled rent will provide a certain stream of income to be capitalized by mortgage financing in the form of additional income producing real estate assets, all of which will allow net income for distribution to the REIT's owners (the participants) in a sure and highly predictable manner.

It is a further object of the present invention to effect an initial public offering (IPO) of shares of the REIT, which will provide liquidity of ownership in the REIT, equity valuation (recorded on a day-to-day basis), and additional capital funds to grow the REIT.

These objects and advantages are realized by providing a novel method of consolidating independent owners of distribution warehouses into a REIT. As part of the method of the present invention, the REIT is formed. A group of independent owners of distribution warehouses willing to participate in ownership of the REIT is assembled. Participants in the REIT are selected from the group of independent owners of distribution warehouses.

As part of or in connection with the selection of the participants, each participant enters into a sale-leaseback agreement with the REIT. The sale-leaseback agreement preferably has terms obligating each participant to sell the participant's warehouse to the REIT and lease it back. The sales price is set at an appraised fair market value of the participant's warehouse. The sale-leaseback agreement may also have terms obligating the participant to lease the warehouse from the REIT after the warehouse is sold to the REIT under a lease agreement. Preferably, the lease agreement provides for a triple-net lease.

The terms of the sale-lease agreement may also require the participant to pay rent to the REIT. Preferably, the rent is determined by a standard formula that charges a uniform rate per square footage of the warehouse so that the participant knows in advance what rent the participant will be required to pay and to assure that the participant's rental rate per square foot is the same rental rate paid by the other participants. The sale-leaseback agreement may also have terms obligating the participant to renew the lease on a periodic basis. Preferably, the participant is obligated to renew the lease at least every seven years and more preferably every seven years.

Each participant's warehouse is appraised to determine its appraised fair market value. Preferably, the appraisal is conducted by at least one appraiser. It is preferred if the appraiser is selected by a lender who issues a non-recourse mortgage loan to the REIT as described below. Each participant pays for the cost of the appraisal for the participant's warehouse and the cost of environmental remediation if so required.

Title in each participant's warehouse is transferred to the REIT. Preferably, title transfer is accomplished when the REIT purchases the warehouse from the participant by paying to the participant the appraised fair market value of the warehouse. After transferring title, each participant continues to pay maintenance expenses, insurance, and/or ad valorum taxes accruing from the participant's warehouse.

If before transferring title to the REIT, a participant has entered into a lease for the participant's warehouse with a distribution company controlled by the participant (e.g., a distribution company in which the participant is a majority shareholder or owner), the lease is preferably cancelled before the participant transfers title to the REIT. This way the warehouse is transferred to the REIT unencumbered by a lease so that the REIT and the participant are free to enter into the lease under the lease agreement with each other as described above.

The REIT purchases each participant's warehouse preferably for a cash payment made to the participant. It is preferred if the amount of the cash payment is 70%-80% of the appraised fair market value of the participant's warehouse. This leaves a balance owed to the participant. The REIT may issue a secured note payable to the participant for the balance owed. It is preferred if the secured note provides that the REIT will pay interest accruing on the balance owed to the participant. Preferably, the interest is paid in monthly installment payments. The secured note may also provide that the REIT will pay the balance owed to the participant in full at the time the REIT obtains a new non-recourse mortgage loan, which preferably is at the end of an initial lease term of at least seven years and more preferably seven-years.

Interest in the secured note may be set at one percent above a prime rate that exists when the REIT issues the secured note. Preferably, the prime rate is the prime rate published in the Wall Street Journal. It is also preferred if the secured note is secured by a second lien on the participant's warehouse. The second lien may be recorded in an appropriate depository or registry to comply with applicable legal recordation requirements.

In accordance with the method of the present invention, the REIT agrees to lease to each participant the warehouse the participant sold to the REIT. Preferably, the REIT and each participant enter into a lease agreement for the specific warehouse. It is preferred if the lease agreement has terms obligating the participant to pay rent to the REIT. The lease agreement preferably is for a term of at least seven years and more preferably seven years. It is also preferred if the lease agreement is a triple-net lease so that the cumulative rent paid by the participants to the REIT equals or is greater than a scheduled debt service on the non-recourse mortgage loan issued to the REIT as discussed below.

In accordance with the method of the present invention, the sale-leaseback agreement and/or the lease agreement specifies a standard formula to compute the rent. Preferably, the standard formula charges a uniform rate per square footage of the warehouse so that the participant knows before they sign the sale-lease agreement and/or the lease agreement what specific annual rent the participant will be required to pay.

Preferably, the rent is established by determining an annual debt service amount for the non-recourse mortgage loan that has or will be issued to the REIT as described below. The total square footage of all the warehouses leased or to be leased by the REIT is determined. The annual debt service amount is divided by the total square footage to derive a first component price per square foot. A second component and a third component are then added to the first component. The second component is preferably an amount dedicated for use by the REIT to pay for general and administrative expenses of the REIT. The third component is preferably an amount dedicated for use by the REIT as working capital and to permit the REIT to make interest payments and cash distributions to each participant.

The addition of the second and third components to the first component results in a formula rental price per square foot. The formula rental price per square foot is multiplied by the square footage of the warehouse leased to the participant to derive the annual rent to be paid by the participant to the REIT. It is preferred if the second component is at least 50 cents per square foot. It is also preferred if the third component is at least 25 cents per square foot.

It is preferred if each sale-leaseback agreement and lease agreement are contemporaneously entered into by the REIT and each participant.

The method of the present invention may also include issuing a non-recourse mortgage loan to the REIT. Preferably, the non-recourse mortgage loan is issued by a lender. It is preferred if the non-recourse mortgage loan is issued for a loaned amount capable of financing at least a portion of the REIT's purchase of the warehouses and preferably the portion constituting the REIT's cash purchase or cash payment to the participant.

The non-recourse mortgage loan may be issued under terms obligating the REIT to make installment payments of principal and interest to the lender on the loaned amount. The REIT may use the rent paid by the participants under the leases to make the installment payments to the lender. Preferably, the non-recourse mortgage loan has a term of at least seven years and more preferably a term of seven years. It is also preferred if the non-recourse mortgage loan is serviced on at least a seven-year debt payment schedule and more preferably a seven-year debt payment schedule.

The lender may require the REIT to pledge the warehouses and/or an assignment of the lease agreements as collateral for the non-recourse mortgage loan. The lender will have a first primary lien on the warehouses.

The REIT may use the non-recourse mortgage loan to finance the cash payment made by the REIT to the participants to purchase their warehouses.

As part of the method of the present invention, an ownership interest in the REIT is transferred to each participant. Preferably, each participant's ownership interest in the REIT is a prorata share of the outstanding shares of the REIT. The participant's prorata ownership share is calculated by dividing the appraised fair market value of the warehouse the participant sold or will sell to the REIT by the total appraised fair market value of all warehouses sold or to be sold to the REIT by all participants.

Under the method of the present invention, each warehouse owned by the REIT may be reappraised to determine the warehouse's reappraised fair market value. The reappraised fair market value of each warehouse is added together and used to calculate the total reappraised fair market value of all of the REIT's warehouses. Preferably, the reappraisal of each warehouse is conducted by at least one appraiser-selected by a lender who issues a new non-recourse mortgage loan to the REIT as described below. It is preferred if the REIT pays for the cost of reappraising the warehouses.

The method of the present invention may include renewing each lease agreement entered into between the REIT and the participants. Preferably, the lease agreements are renewed for at least an additional seven year term and more preferably for an additional seven year term, with rental prices re-calculated on the same formula basis.

In accordance with the method of the present invention, a new non-recourse mortgage loan is issued to the REIT for a loaned amount that is 70%-80% of the total reappraised fair market value of all of the warehouses. Preferably, the new non-recourse mortgage loan is issued by a lender. The new non-recourse mortgage loan may provide proceeds to the REIT.

The REIT invests the proceeds provided by the new non-recourse mortgage loan in at least one investment capable of producing investment revenue. It is preferred if the proceeds of the new non-recourse mortgage loan are invested in a variety of multiple investments. Preferably, the REIT's Board of Directors selects the investments. It is preferred if the investments include income producing real estate. The REIT preferably distributes at least 90% of net earnings from the investment revenue produced by the investment to the participants. Preferably, 90% of the net earnings are distributed by the REIT to the participants annually.

Preferably, the events of (1) reappraising each warehouse, (2) renewing each lease agreement, (3) issuing new non-recourse mortgage loan to the REIT, and (4) investing the proceeds from the new non-recourse mortgage loan, occur on a periodic basis, as for example, at least every seven years or every seven years.

In another embodiment of the present invention, a manager is employed by and/or for the REIT. The manager may be responsible for general and administrative operations of the REIT, including managing the real estate investment assets owned by the REIT. It is preferred if the manager acquires an ownership interest in the REIT.

The REIT may pay the manager an annual management fee. It is preferred if the management fee is an amount, preferably a fixed amount, that is computed by multiplying the second component price per square foot (e.g. 50 cents per square foot) by the total square footage of all the warehouses owned or to be owned by the REIT.

It is preferred if the manager has a one-percent ownership interest in the REIT. In this instance, each participant's ownership interest in the REIT will be a prorata share of the outstanding or remaining 99% interest of the REIT. Each participant's prorata ownership share of the REIT maybe calculated by dividing the appraised fair market value of the warehouse sold or to be sold by the participant to the REIT by the total appraised fair market value of all of the warehouses sold or to be sold by the participants to the REIT.

In another embodiment of the present invention, the REIT may purchase and obtain title to any leasehold improvement made by the participant to the leased warehouse during the term of the lease agreement. It is preferred if the REIT pays the participant an amount that is or constitutes the participant's original cost for the leasehold improvement. It is also preferred if the REIT's purchase of the leasehold improvement is accomplished at the time the lease agreement is renewed.

In a further embodiment of the present invention, an initial public offering of REIT's stock may be made. It is preferred that the stock is publicly offered on a recognized stock exchange. It is also preferred if the initial public offering is approved by the Board of Directors of the REIT.

The REIT may be created and/or operated as described herein through the use of a computer system and computer applications, including a database containing the REIT's business, financial, and investment records, as for example, sale-leaseback agreements, lease agreements, investments, investment revenue, proceeds, net earnings, and distributions made to the participants.

The computer system may include a CPU which executes instructions that implement the database server application and stores information. The computer system may preferably include network interface so that the database may be accessed through other computers on a local area network. The computer system also preferably includes a communication device, e.g. a telephone modem, a cable modem, a DSL modem, or other similar device, capable of communicating data between computers on a systems and a wide area network. The communication devices may be used to connect the computer system through the internet or intranet in order to permit users at remote locations to access data in the database. A printer or printers may be connected to the computer system to create database reports.

### BRIEF DESCRIPTION OF THE DRAWINGS

FIG. 1 is flowchart depicting the steps of forming the REIT, assembling a group of independent owners of distribution warehouses, selecting participants in the ownership of the REIT, and appraising each participant's warehouse, which steps form part of an embodiment of the method of the present invention.

FIG. 2 is a flowchart depicting the further steps of transferring title in each warehouse from the participants to the REIT and leasing the warehouses after transfer back to the participants, which steps form part of the embodiment of the method of the present invention.

FIG. 3 is a flowchart depicting the further step of issuing a non-recourse mortgage loan to the REIT, which step forms part of the embodiment of the method of the present invention.

FIG. 4 is a flowchart depicting the further steps of transferring ownership in the REIT to the participants, reappraising each warehouse, and renewing each lease agreement, which steps form part of the embodiment of the method of the present invention.

FIG. 5 is a flowchart depicting the further steps of issuing a new non-recourse mortgage loan to the REIT, investing proceeds from the new non-recourse mortgage loan, and distributing at least 90% of net earnings from the investments to the participants, which steps form part of the embodiment of the method of the present invention.

FIG. 6 depicts the terms of the sale-leaseback agreement, which may be included as part of the embodiment of the method of the present invention.

FIG. 7 depicts the terms of the lease agreement, which may be included as part of the embodiment of the method of the present invention.

FIG. 8 depicts the procedure that may be used to establish the rent to be paid by the participants, which may be included as part of the embodiment of the method of the present invention.

FIG. 9 depicts an alternative step of employing a manager for the REIT, which step may be included as part of the embodiment of the method of the present invention.

FIG. 10 depicts alternative step of the REIT purchasing leasehold improvements made by the participants, which step may be included as part of the embodiment of the method of the present invention.

FIG. 11 depicts alternative step of the REIT's stock being subject to an IPO, which step may be included as part of the embodiment of the method of the present invention.

### DETAILED DESCRIPTION OF PREFERRED EMBODIMENTS

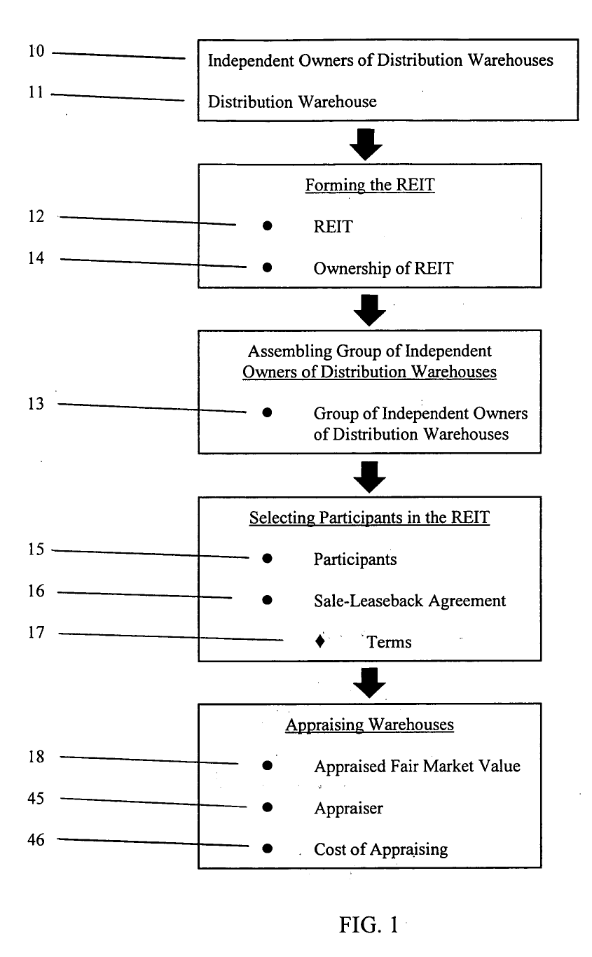

With reference to the figures where like elements have been given like numerical designation to facilitate an understanding of the present invention, and particularly with reference to the embodiment of the method of the present invention illustrated in FIGS. 1 through 5, the method of the present invention involves consolidating independent owners 10 of distribution warehouses 11 into a Real Estate Investment Trust or REIT 12.

As shown in FIG. 1, REIT 12 is formed. REIT 12 may be formed by completing and filing all required paperwork in compliance with applicable law. The formation of REIT 12 would be well understood by one of ordinary skill in the art to which the invention pertains. REIT 12 may be formed by any person or entity desiring to form REIT 12. For example, REIT 12 may be formed by any person or entity wishing to be a participant 15 in REIT 12 or by any person or entity wishing to manage or control REIT 12, as for instance, manager 93.

FIG. 1 also shows owners 10 being assembled into group of independent owners 13 of distribution warehouses 11 who are willing to participate in REIT 12. Group of independent owners 13 may be assembled by any person or entity desiring to assemble group of independent owners 13. Preferably, group of independent owners 13 is assembled by any person or entity who formed REIT 12 or by any person or entity desiring to associate with, participate in, manage, or control REIT 12. For example, group of independent owners 13 may be assembled by any person or entity wishing to be a participant 15 in REIT 12 or by any person or entity wishing to manage or control REIT 12, as for instance, manager 93.

As illustrated in FIG. 1, participants 15 are selected to participate in REIT 12 from group of independent owners 13 of distribution warehouses 11. Any person or entity may select participants 15 to participate in REIT 12. Preferably, a person or entity having an interest in REIT 12 selects participants 15. Such persons may include one or more owners 10 who are part of group of independent owners 13 of distribution warehouses 11, an actual or potential participant 15, an actual or potential manager 93, and/or lender 27.

It is preferred that participants 15 are selected to participate in REIT 12 by having each owner 10 from group of independent owners 13 of distribution warehouses 11 provide a financial statement to the person(s) and/or entity(ies) selecting participants 15. More preferably, each owner 10 from group of independent owners 13 of distribution warehouses 11 provides a financial statement for each of the past five years preceding the current year.

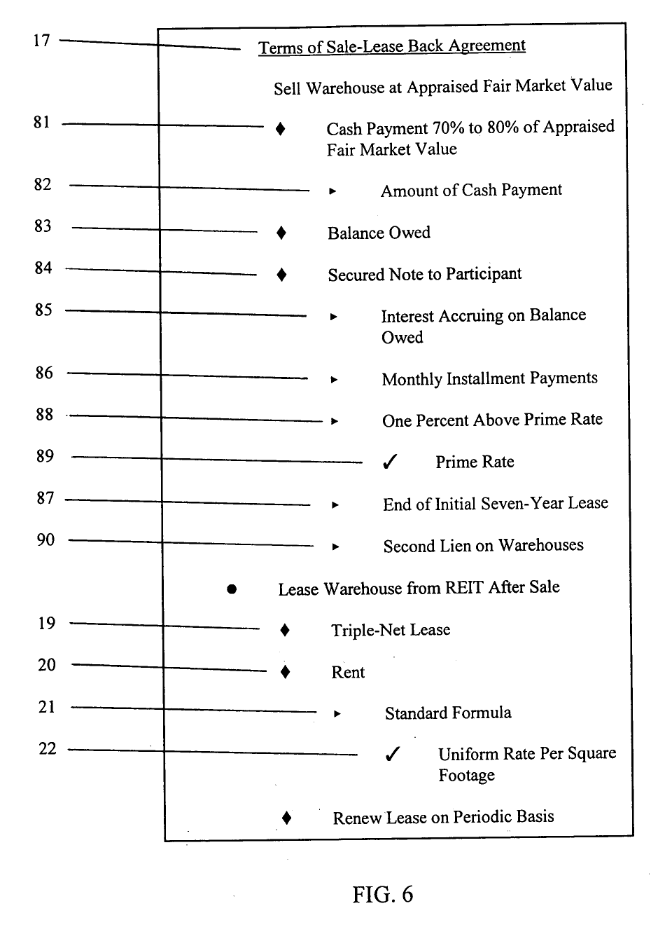

FIGS. 1 and 6 show that as part of or in connection with the selection of participants 15, each participant 15 preferably enters into sale-leaseback agreement 16 with REIT 12. Sale-leaseback agreement 16 may include terms 17. Terms 17 of sale-leaseback agreement 16 preferably obligate participant 15 to sell warehouse 11 owned by participant 15 to REIT 12 and for REIT 12 to purchase warehouse 11 from participant 15. Terms 17 of sale-leaseback agreement 16 may also provide that the sales price for warehouse 11 is set at appraised fair market value 18 of warehouse 11 owned by participant 15. Terms 17 of sale-leaseback agreement 16 may also obligate participant 15 to lease warehouse 11 from REIT 12 under lease agreement 24 that provides for triple-net lease 19 after warehouse 11 is sold to and purchased by REIT 12.

Terms 17 of sale-leaseback agreement 16 may also require participant 15 to pay rent 20 to REIT 12. Preferably, terms 17 of sale-leaseback agreement 16 provide that rent 20 is determined by standard formula 21 that charges uniform rate per square footage 22 for warehouse 11 so that participant 15 knows in advance what rent 20 participant 15 will be required to pay to REIT 12.

Terms 17 of sale-leaseback agreement 16 may also obligate participant 15 to renew lease agreement 24 on a periodic basis. Preferably, participant 15 is obligated to renew lease agreement 24 at least every seven years and more preferably, every seven years.

FIG. 6 illustrates that terms 17 of sale-leaseback agreement 16 may obligate REIT 12 to purchase warehouse 11 owned by participant 15. Preferably, terms 17 of sale-leaseback agreement 16 specify that REIT 12 will purchase warehouse 11 from participant 15 for fair market value 18 of warehouse 11. It is further preferred if terms 17 of sale-leaseback agreement 16 further specify that REIT 12 will pay participant 15 cash payment 81.

Cash payment 81 is preferably amount 82 which is 70%-80% of appraised fair market value 18 of warehouse 11 thereby leaving balance owed 83. Terms 17 of sale-leaseback agreement may require REIT 12 to issue secured note 84 payable to participant 15 for balance owed 83. It is preferred if secured note 84 provides that REIT 12 will pay interest 85 accruing on balance owed 83 to participant 15. Preferably, interest 85 is paid in monthly installment payments 86. More preferably, secured note 84 provides that REIT 12 will pay balance owed 83 in full to participant 15 at the time REIT 12 obtains new non-recourse mortgage loan 38, preferably at end 87 of initial seven-year lease.

With reference to FIG. 1, warehouse 11 owned by each participant 15 is appraised to determine appraised fair market value 18. Preferably, the appraisal is conducted by at least one appraiser 45. It is preferred if appraiser 45 is selected by lender 27 who issues non-recourse mortgage loan 26 to REIT 12. It is further preferred if appraiser 45 is an MAI appraiser. Participant 15 preferably pays for cost 46 of the appraisal of warehouse 11 owned by participant 15.

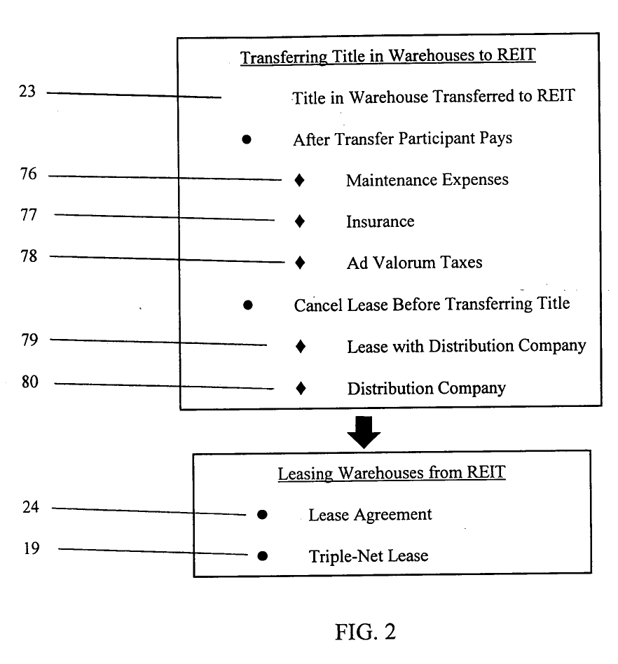

FIG. 2 reveals that title 23 of warehouse 11 owned by each participant 15 is transferred to REIT 12. Transfer of title 23 in warehouse 11 owned by each participant 15 may be accomplished when REIT 12 purchases warehouse 11 from participant 15 by paying participant 15 appraised fair market value 18 of warehouse 11. After transferring title 23 in warehouse 11, each participant 15 continues to pays maintenance expenses 76, insurance 77, and/or ad valorum taxes 78 accruing from warehouse 11 that participant 15 sold to REIT 12.

Again with reference to FIG. 2, if before transferring title 23 in warehouse 11 to REIT 12, participant 15 has entered into lease 79 for warehouse 11 with distribution company 80 controlled by participant 15, lease 79 is preferably cancelled before participant 15 transfers title 23 in warehouse 11 to REIT 12. Thus, title 23 in warehouse 11 is transferred to REIT 12 unencumbered by lease 79 so that REIT 12 and participant 15 are free to enter into triple-net lease 19 by signing and entering into lease agreement 16 for warehouse 11.

It is preferred if transfer of title 23 in warehouse 11 of each participant 15 to REIT 12 occurs in conjunction with or as part of the purchase by REIT 12 of warehouse 11 from each participant 15.

The purchase of warehouse 11 by REIT 12 from each participant 15 may be accomplished as part of sale-leaseback agreement 16 or may be accomplished by REIT 12 and each participant 15 entering into separate purchase or buy-sell agreements or comparable agreements. The required agreements to effect transfer of title 23 in each warehouse 11 to REIT 12 and the purchase of each warehouse 11 by REIT 12 would be understood by a skilled artisan to which the subject matter of the present invention pertains.

REIT 12 purchases warehouse 11 from each participant 15 by paying to participant 15 fair market value 18 of warehouse 11. Preferably, REIT 12 pays participant 15 cash payment 81 which may be amount 82 which is 70%-80% of appraised fair market value 18 of warehouse 11 thereby leaving balance owed 83. REIT 12 may issue secured note 84 payable to participant 15 for balance owed 83. It is preferred if secured note 84 provides that REIT 12 will pay interest 85 accruing on balance owed 83 to participant 15. Preferably, interest 85 is paid in monthly installment payments 86. More preferably, secured note 84 provides that REIT 12 will pay balance owed 83 in full to participant 15 at the time REIT 12 obtains new non-recourse mortgage loan 38 at end 87 of the initial seven-year lease.

The money received by each participant from REIT 12, as for example money from cash payment 81, monthly installment payments 86, and payment of balance owed 83, may be used by participant 15 as deemed necessary. For example, participant 15 could use the money to pay off debt or could invest in short-term municipal bonds or other investments that will produce income to participant 15.

Interest 85 in secured note 84 is preferably set at one-percent above 88 prime rate 89 that exists when REIT 12 issues secured note 84. Preferably, prime rate 89 is the prime rate published in the Wall Street Journal. It is also preferred if secured note 84 is secured by second lien 90 on warehouse 11 sold by participant 15 to REIT 12. Second lien 90 may be recorded in the appropriate depository or registry to comply with applicable recordation requirements.

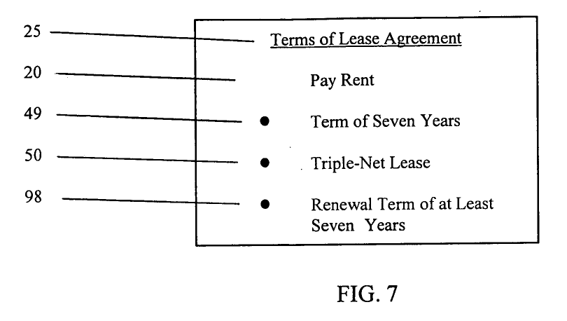

With reference to FIGS. 2 and 7, REIT 12 and each participant 15 enter into lease agreement 24 for warehouse 11 sold by participant 15 to REIT 12. It is preferred if lease agreement 24 has terms 25 obligating participant 15 to pay rent 20 to REIT 12. Lease agreement 24 is preferably for term 49 of at least seven years and more preferably seven years. Lease agreement 24 preferably is triple-net lease 50 so that rent 20 paid by all participants 15 to REIT 12 equals or is greater than scheduled debt service 51 on non-recourse mortgage loan 26 issued to REIT 12.

Sale-leaseback agreement 16 and/or lease agreement 24 may specify standard formula 21 that charges uniform rate per square footage 22 of warehouse 11 so that participant 15 knows before entering sale-lease agreement 16 and/or lease agreement 24 what specific annual rent 65 participant 15 will be required to pay to REIT 12 for warehouse 11.

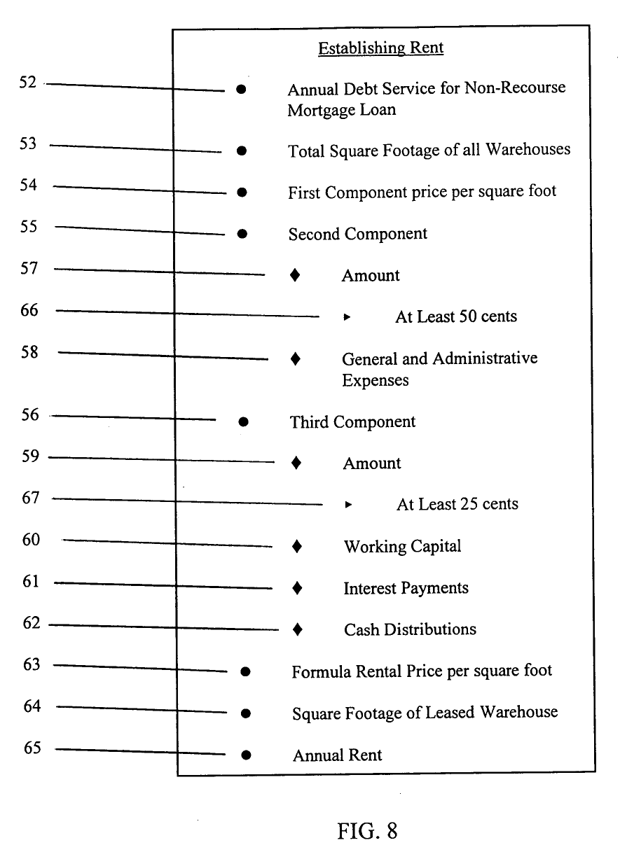

As shown in FIG. 8, rent 20 is established by determining annual debt service amount 52 for non-recourse mortgage loan 26 that issued or will issue to REIT 12. Total square footage 53 of all warehouses 11 leased or to be leased by REIT 12 is determined. Annual debt service amount 52 is divided by total square footage 53 to derive first component price per square foot 54. Second component 55 and third component 56 are then added to first component 54. Second component 55 is amount 57 which is dedicated for use by REIT 12 to pay for general and administrative expenses 58 of REIT 12. Third component 56 is amount 59 which is dedicated for use by REIT 12 as working capital 60 and to permit REIT 12 to make interest payments 61 and cash distributions 62 to participants 15.

The addition of second component 55 and third component 56 to first component 54 results in formula rental price per square foot 63. Formula rental price per square foot 63 is multiplied by square footage 64 of warehouse 11 leased or to be leased to participant 15 to derive annual rent 65 to be paid by participant 15 to REIT 12. It is preferred if second component 55 is at least 50 cents per square foot 66 and more preferably, 50 cents per square foot. It is also preferred if third component 56 is at least 25 cents per square foot 67 and more preferably 25 cents per square foot.

By way of example, if non-recourse mortgage loan 26 is 160 million dollars which is amortized over seven years at an interest rate of 5.5%, the annual payment of principal and interest, which is annual debt service 52, will be $27,588,000. Assuming there is 10 million total square footage 53 of warehouses 11, annual debt service 52 of $27,588,000 is divided by total square footage 53 of 10 million square feet to derive first component price per square foot 54 of $2.75 per square foot. Second component 55 of 50 cents per square foot (covering general and administrative expenses 58) and third component 56 of 25 cents per square foot (covering working capital 60, interest payments 61, and cash distributions 62) are added to first component price per square foot 54 of $2.75 per square foot to derive formula rental price per square foot 63 of $3.50 per square foot.

By determining annual rent 65 using formula rental price per square foot 63, a safeguard is implemented which protects participants 15 against REIT 12 arbitrarily setting annual rent 65. Also, the procedure prevents REIT 12 from paying out general and administrative expenses 58 that exceed that portion of annual rent 65 (first component 54 of 50 cents per square foot) collected by REIT 12, which is dedicated for use by REIT 12 for general and administrative expenses 58.

It is preferred if each sale-leaseback agreement 16 and lease agreement 24 are contemporaneously entered into by REIT 12 and participant 15.

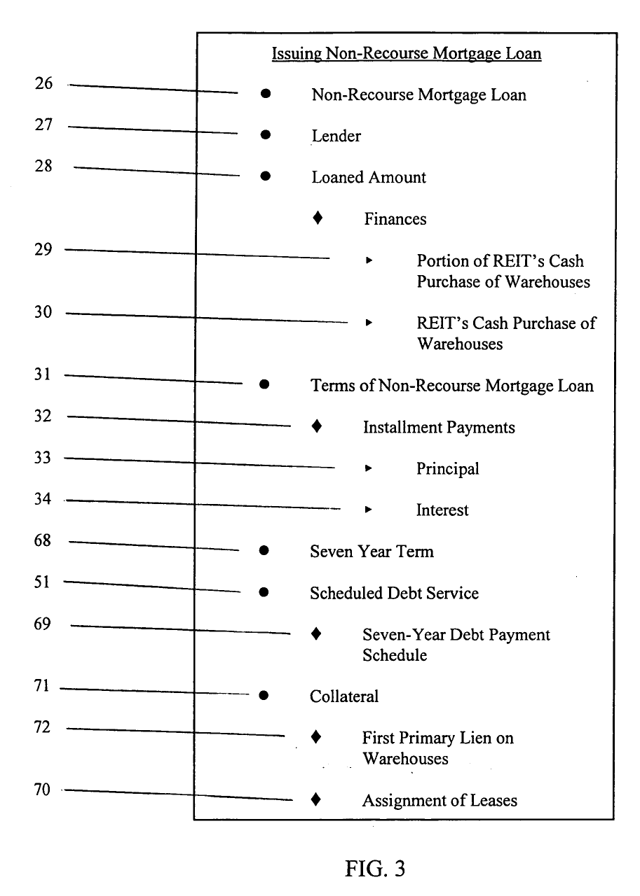

FIG. 3 illustrates that non-recourse mortgage loan 26 is issued to REIT 12. Preferably, non-recourse mortgage loan 26 is issued by lender 27. It is preferred if non-recourse mortgage loan 26 is issued for loaned amount 28 which is capable of financing at least portion 29 of cash purchase 30 made by REIT 12 for warehouses 11. Lender 27 is preferably a banking institution, as for example, a bank or savings and loan.

Non-recourse mortgage loan 26 may be issued under terms 31 obligating REIT 12 to make installment payments 32 of principal 33 and interest 34 to lender 27 on loaned amount 28. REIT 12 may use rent 20 paid by participants 15 to make installment payments 32 to lender 27. Preferably, non-recourse mortgage loan 26 has term 68 of at least seven years and more preferably seven years. It is also preferred if non-recourse mortgage loan 26 is serviced on at least seven-year debt payment schedule 69 and more preferably a seven-year debt payment schedule 69.

Lender 27 may require REIT 12 to pledge warehouses 11 and/or assignment 70 of lease agreements 24 as collateral 71 for non-recourse mortgage loan 26. Lender 27 will have first primary lien 72 on warehouses 11. Non-recourse mortgage loan 26 preferably finances cash payment 81 made by REIT 12 to participants 15 to purchase warehouses 11.

Non-recourse mortgage loan 26 and new non-recourse mortgage loan 38 (because they are non-recourse) mean that REIT 12 will not have to endorse or guarantee, either through the corporate entity or individually through participants 15, payment of non-recourse mortgage loan 26 and/or new non-recourse mortgage loan 38.

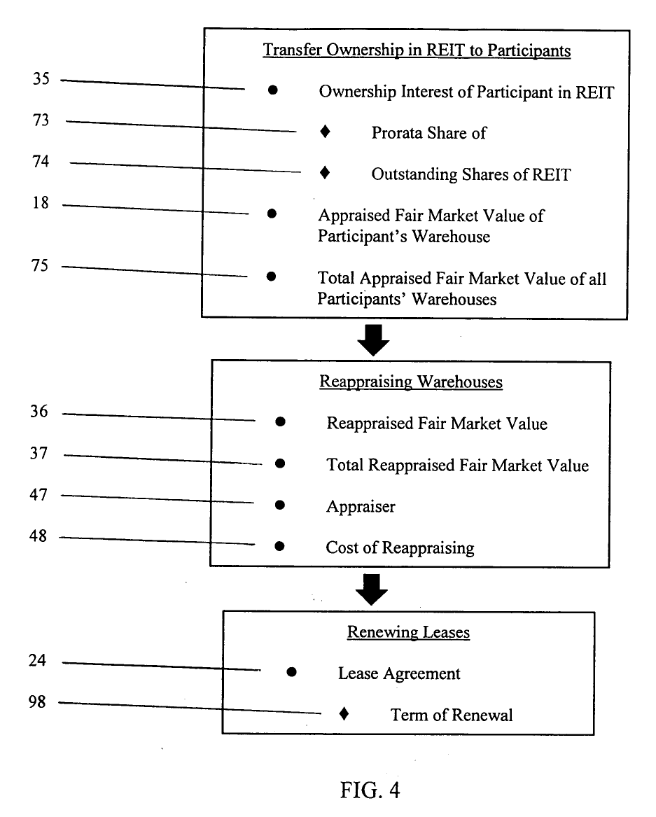

As shown in FIG. 4, ownership interest 35 in REIT 12 is transferred to each participant 15. Preferably, ownership interest 35 of each participant 15 in REIT 12 is prorata share 73 of outstanding shares 74 of REIT 12. Prorata share 73 of ownership interest 35 of participant 15 in REIT 12 is calculated by dividing appraised fair market value 18 of warehouse 11 sold or to be sold by participant 15 to REIT 12 by total appraised fair market value 75 of all warehouses 11 sold or to be sold by all participants to REIT 12.

As an example, if warehouse 11 sold or to be sold by participant 15 to REIT 12 has appraised fair market value 18 of $1 million and total appraised fair market value 75 of all warehouses 11 sold or to be sold by all participants to REIT 12 is $200 million, participant will receive a 0.5 or ½% ownership interest 35 in REIT 12.

As shown in FIG. 4, each warehouse 11 owned by REIT 12 may be reappraised to determine reappraised fair market value 36 thereof. Reappraised fair market value 36 of each warehouse 11 is used to calculate (by adding) total reappraised fair market value 37 of all warehouses 11 owned by REIT 12. Preferably, the reappraisal is conducted by at least one appraiser 47 (preferably an MAI appraiser) selected by lender 40 who issues new non-recourse mortgage loan 38 to REIT 12. It is preferred if REIT 12 pays for cost 48 of reappraising warehouses 11.

Again with reference to FIG. 4, each lease agreement 24 entered into between REIT 12 and participants 15 may be renewed. Preferably, lease agreements 24 are renewed for term 98 of at least seven years and more preferably seven years.

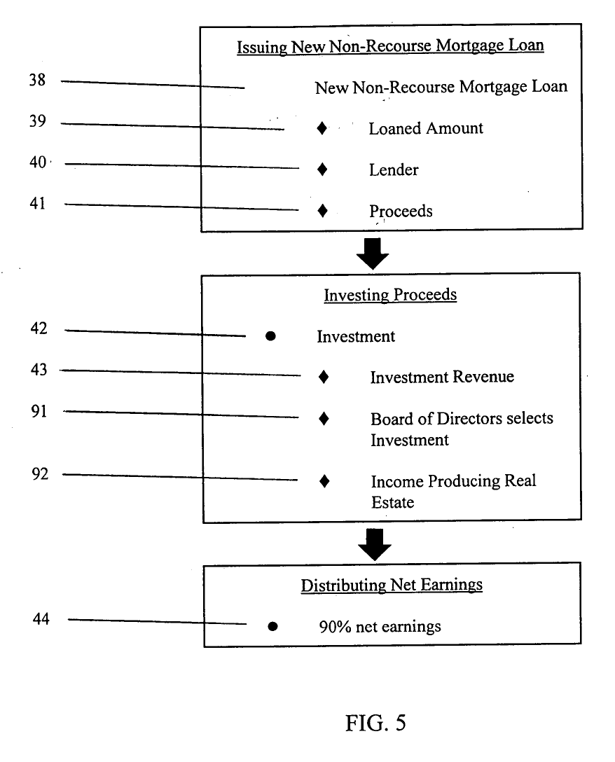

With reference to FIG. 5, new non-recourse mortgage loan 38 is issued to REIT 12 for loaned amount 39 that is 70%-80% of total reappraised fair market value 37 of all warehouses 11. Preferably, new non-recourse mortgage loan 38 is issued by lender 40. New non-recourse mortgage loan 38 provides proceeds 41 to REIT 12.

Lender 40 is preferably a banking institution, as for example, a bank or savings and loan. Lender 27 and lender 40 may be the same lending institution or different lending institutions. REIT 12 or preferably Board of Directors 91 of REIT 12 may select lender 27 and/or lender 40.

As referenced in FIG. 5, REIT 12 may invest proceeds 41 in at least one investment 42 capable of producing investment revenue 43. Preferably, Board of Directors 91 of REIT 12 selects investment 42. It is preferred if multiple investments 42 are made by REIT 12 using proceeds 41. It is also preferred if investment 42 includes income producing real estate 92. REIT 12 preferably distributes at least 90% of net earnings 44 from investment revenue 43 to participants 15.

It is preferred if the events of (1) reappraising each warehouse 11, (2) renewing each lease agreement 24, (3) issuing new non-recourse mortgage loan 38 to REIT 12, and (4) investing proceeds 41 from new non-recourse mortgage loan 38, occur or take place on a periodic basis, preferably at least every seven years, and more preferably every seven years.

Because REIT 12 and each participant 15 are lessor and lessee of warehouses 11, lease agreements 24 can be redrawn at any time and warehouses 11 reappraised and re-mortgaged. The ability to control lease agreements 24 and re-mortgage warehouses 11 on a periodic basis, or preferably every seven years, permits REIT 12 to “pump” out the equity of warehouses 11 preferably every seven years and invest proceeds 41 in carefully selected investments 42 which are preferably real estate investments. Investing proceeds 41 in investments 42 is accomplished by processes well understood by one of ordinary skill in the art to which the invention pertains. Such investment of proceeds 41 should be based on sound investment strategies that maximize the income earning potential of investments 42.

As an example, if REIT 12 starts with 10 million total square feet 53 of warehouses 11, total appraised fair market value 75 of warehouses 11 will be about $200 million ($20 per square foot). The “pump” out every seven years will be about 62% to 70% multiplied by $200 million, which equals about $100 million to be invested in investments 42. Over a period of 50 to 100 years, REIT 12 will likely assume a size that will make REIT 12 one of the largest REITs of its kind. Moreover, there is never any leverage or borrowing on investments 42 made by REIT 12, although this is an option. Only warehouses 11 are remortgaged.

Investments 42 will likely increase in value thereby increasing the equity of REIT 12. Over time, REIT 12 will be more valuable to participants 15 than ownership of their respective distribution companies and/or warehouses 11. If distribution companies owned by or constituting participants 15 ever cease to exist, for whatever reason, participants 15 will still have their ownership interests 35 in REIT 12.

Again with reference to FIG. 5, net earnings 44 from investment revenue 43 generated from investments 42 will be distributed by REIT 12 to participants 15 each year, if net earnings 44 have been generated during the existing year. Applicable law requires REIT 12 to distribute at least 90% of net earnings 44 on an annual basis to qualify as a REIT and to avoid federal corporate income tax.

Net earnings 44 of REIT 12 will never be compromised by exorbitant overhead since the overhead of REIT 12 must be contained and encompassed with annual management fee 96 based on amount 97 which is derived using first component price per square foot 54, preferably in the amount of 50 cents per square foot. As stated above, first component price per square foot 54 is dedicated for general and administrative expenses 58 of REIT 12.

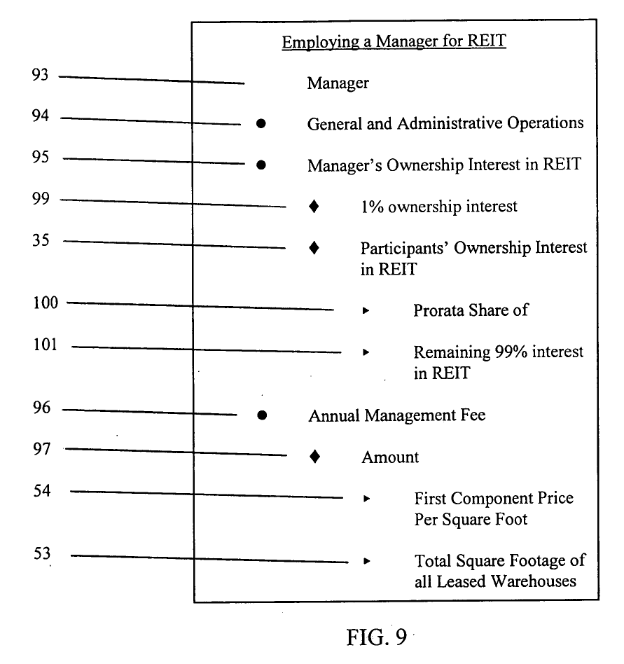

An alternative embodiment of the present invention is shown in FIG. 9. In this embodiment, manager 93 is employed by and for REIT 12. Manager 93 may be responsible for general and administrative operations 94 of REIT 12. It is preferred if manager 93 acquires ownership interest 95 in REIT 12.

REIT 12 may pay manager 93 annual management fee 96. It is preferred if annual management fee 96 is amount 97 that is computed by multiplying first component price per square foot 54 by total square footage 53 of all warehouses 11.

It is preferred if manager 93 has one-percent ownership interest 99 in REIT 12. In this case, each ownership interest 35 of participant 15 in REIT 12 is prorata share 100 of remaining 99% interest 101 of REIT 12. Prorata share 100 of ownership interest 99 of participants 15 in REIT 12 is calculated by dividing appraised fair market value 18 of warehouse 11 sold or to be sold by participant 15 to REIT 12 by total appraised fair market value 75 of all warehouses 11 sold or to be sold by all participants to REIT 12.

Manager 93 of REIT 12 preferably attempts to secure for participants 15 and for REIT 12 all economies of scale that can be negotiated on the strength of the consolidation as provided by REIT 12. Such economies of scale may be negotiated in areas of truck purchases, truck rentals, freight, warehouse equipment, purchases and rental, warehouse security systems, technological systems for warehouse operations, insurance on warehouses 11, taxes on warehouse property and the like.

Manager 93 of REIT 12 may also act as a buying group for participants 15 without charging participants 15 for the service. This will permit rebates from purchases from preferred vendors within a buying group to be passed through to participants 15 at 100 cents on the dollar thus saving participants 15 the amount of rebate which is customarily held back by buying groups to fund the buying groups' operation. For example, most buying groups retain anywhere from 10 cents to 20 cents on the dollar of every rebate paid by the preferred vendors. With REIT 12 handling the same chores as a buying group, collecting and dispersing rebates to participants 15, rebate funds could go entirely to participants 15.

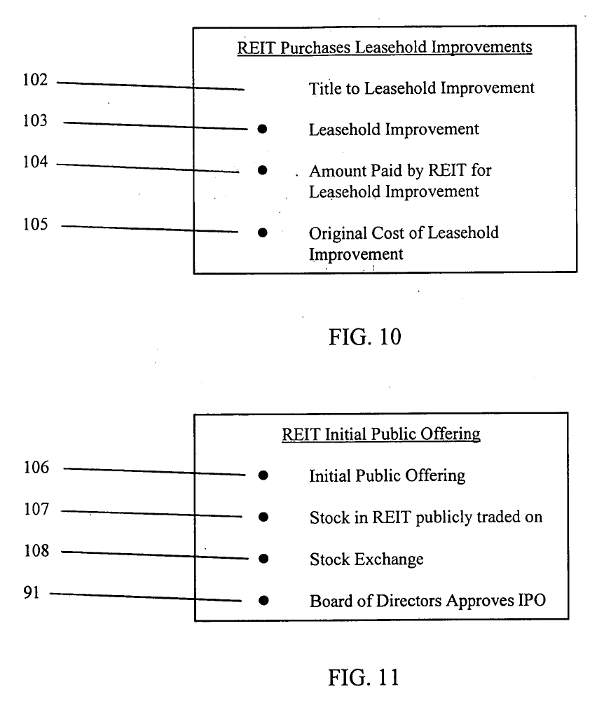

FIG. 10 shows another alternative embodiment of the present invention in which REIT 12 purchases and obtains title 102 to leasehold improvement 103 made by participant 15 in warehouse 11 during term 49 of lease agreement 24 or renewal term 98 thereof. It is preferred if REIT 12 pays participant 15 an amount 104 that is original cost 105 of participant 15 for leasehold improvement 103. It is also preferred if purchase of leasehold improvement 103 by REIT 12 is accomplished at the time lease agreement 24 is renewed.

FIG. 11 also shows an alternative embodiment of the present invention wherein stock 102 in REIT 12 is subject to initial public offering 106. It is preferred that stock 107 of REIT 12 is publicly offered on a recognized stock exchange 108. It is also preferred if initial public offering 106 is approved by Board of Directors 91 of REIT 12.

While preferred embodiments of the present invention have been described, it is to be understood that the embodiments described are illustrative only and that the scope of the invention is to be defined only by the appended claims when accorded a full range of equivalence, many variations and modifications naturally occurring to those skilled in the art from a perusal hereof.

1. A method of consolidating independent owners of distribution warehouses into a Real Estate Investment Trust (REIT), comprising the steps of:
a) forming the REIT;
b) assembling a group of independent owners of distribution warehouses willing to participate in ownership of the REIT;
c) selecting participants in the REIT from the group of owners whereby the participants each enter into a sale-leaseback agreement with the REIT, the sale-leaseback agreement comprising terms obligating the participant to sell the participant's warehouse to the REIT at an appraised fair market value thereof, to lease the warehouse from the REIT after sale thereof under a lease agreement providing for a triple-net lease and requiring the participant to pay rent to the REIT, the rent being determined by a standard formula that charges a uniform rate per square footage of the warehouse so that the participant knows in advance what rent the participant will be required to pay, and to renew the lease agreement on a periodic basis;
d) appraising each participant's warehouse to determine the appraised fair market value thereof;
e) transferring title in each participant's warehouse to the REIT, the transferring of title being accomplished when the REIT purchases the warehouse from the participant for the appraised fair market value thereof;
f) leasing each warehouse to the participant from whom the REIT purchased the warehouse, the leasing of each warehouse occurring when the REIT and each participant enter into the lease agreement, the lease agreement comprising terms obligating the participant to pay rent to the REIT;
g) issuing a non-recourse mortgage loan to the REIT, the non-recourse mortgage loan being issued by a lender for a loaned amount which is capable of financing at least a portion of the REIT's cash purchase of the warehouses, the non-recourse mortgage loan comprising terms obligating the REIT to make installment payments of principal and interest to the lender on the loaned amount, whereby the REIT uses the rent paid by the participants to make the installment payments;
h) transferring an ownership interest in the REIT to each participant;
i) reappraising each warehouse to determine a reappraised fair market value thereof and using the reappraised fair market value of each warehouse to calculate a total reappraised fair market value of all of the warehouses;
j) renewing each lease;
k) issuing a new non-recourse mortgage loan to the REIT for a loaned amount that is 70% to 80% of the total reappraised fair market value of all of the warehouses, the new non-recourse mortgage loan being issued by a lender, the new non-recourse mortgage loan providing proceeds to the REIT;
l) investing the proceeds provided by the new non-recourse mortgage loan in at least one investment capable of producing investment revenue; and
m) distributing at least 90% of net earnings from the investment revenue produced by the at least one investment to the participants.

2. The method according to claim 1, wherein the terms of the sale-leaseback agreement obligate each participant to renew the lease for the participant's warehouse at least every seven years.

3. The method according to claim 1, wherein in step (d) the appraising of each participant's warehouse is conducted by at least one appraiser selected by the lender and wherein each participant pays for cost of appraising the participant's warehouse.

4. The method according to claim 1, wherein in step (i) the reappraising of each warehouse is conducted by at least one appraiser selected by the lender and wherein the REIT pays for cost of reappraising the warehouses.

5. The method according to claim 1, wherein each lease agreement is for a term of at least seven years.

6. The method according to claim 1, wherein each lease agreement is a triple-net lease so that the rent paid by the participants to the REIT equals or is greater than a scheduled debt service on the non-recourse mortgage loan.

7. The method according to claim 1, wherein the rent is established by a method comprising the steps of:
a) determining an annual debt service amount for the non-recourse mortgage loan;
b) determining a total square footage of all the warehouses leased by the REIT;
c) dividing the annual debt service amount by the total square footage to derive a first component price per square foot;
d) adding to the first component a second component and a third component, the second component being an amount dedicated for use by the REIT to pay for general and administrative expenses of the REIT and the third component being an amount dedicated for use by the REIT as a working capital and to permit the REIT to make interest payments and cash distributions to each participant; the addition of the second and third components to the first component resulting in a formula rental price per square foot; and
e) multiplying the formula rental price per square foot by a square footage of the warehouse leased to the participant to derive an annual rent to be paid by the participant to the REIT.

8. The method according to claim 7, wherein the second component is at least 50 cents per square foot.

9. The method according to claim 7, wherein the third component is at least 25 cents per square foot.

10. The method according to claim 1, wherein the sale-leaseback agreement and the lease agreement are contemporaneously entered into by the REIT and the participant.

11. The method according to claim 1, wherein the non-recourse mortgage loan has a term of at least seven years and is serviced on at least a seven-year debt payment schedule.

12. The method according to claim 1, wherein the REIT pledges the warehouses and an assignment of the lease agreements to the lender as collateral for the non-recourse mortgage loan, the lender having a first primary lien on the warehouses.

13. The method according to claim 1, wherein each participant's ownership interest in the REIT is a prorata share of outstanding shares of the REIT, the prorata share being calculated by dividing the appraised fair market value of the participant's warehouse by a total appraised fair market value of all of the participants' warehouses.

14. The method according to claim 1, wherein each participant continues to pay maintenance expenses, insurance, and ad valorum taxes accruing from the participant's warehouse after transfer of the title thereof to the REIT.

15. The method according to claim 1, wherein if the participant has entered into a lease for the participant's warehouse with a distribution company controlled by the participant, the lease is cancelled before the participant transfers title in the warehouse to the REIT.

16. The method according to claim 1, wherein steps (i)-(l) occur at least every seven years.

17. The method according to claim 1, wherein the REIT purchases each participant's warehouse for a cash payment to the participant of an amount that is 70% to 80% of the appraised fair market value of the warehouse leaving a balance owed and issues a secured note payable to the participant for the balance owed.

18. The method according to claim 17, wherein the secured note provides that the REIT will pay interest accruing on the balance owed to the participant in monthly installment payments.

19. The method according to claim 18, wherein the secured note provides that the REIT will pay the balance owed in full to the participant at the time the REIT obtains the new non-recourse mortgage loan at the end of an initial seven-year lease term.

20. The method according to claim 18, wherein the interest provided in the secured note is set at one percent above a prime rate that exists when the REIT issues the secured note.

21. The method according to claim 17, wherein the secured note is secured by a second lien on the warehouse.

22. The method according to claim 17, wherein the non-recourse mortgage loan issued to the REIT finances the cash payment made by the REIT to each participant.

23. The method according to claim 1, wherein a board of directors of the REIT selects the at least one investment.

24. The method according to claim 23, wherein the at least one investment comprises income producing real estate.

25. A method of consolidating independent owners of distribution warehouses into a Real Estate Investment Trust (REIT), comprising the steps of:
a) forming the REIT;
b) assembling a group of independent owners of distribution warehouses willing to participate in ownership of the REIT;
c) selecting participants in the REIT from the group of owners whereby the participants each enter into a sale-leaseback agreement with the REIT, the sale-leaseback agreement comprising terms obligating the participant to sell the participant's warehouse to the REIT at an appraised fair market value thereof, to lease the warehouse from the REIT after sale thereof by entering into a lease agreement providing for a triple-net lease and requiring the participant to pay rent to the REIT, the rent being determined by a standard formula that charges a uniform rate per square footage of warehouse so that the participant knows in advance what rent the participant will be required to pay, and to renew the lease agreement at least every seven years;
d) appraising each participant's warehouse to determine the appraised fair market value thereof, the appraising being conducted by at least one appraiser selected by the lender and wherein each participant pays for the cost of appraising the participant's warehouse;
e) transferring title in each participant's warehouse to the REIT, the transferring of title being accomplished when the REIT purchases the warehouse from the participant for the appraised fair market value thereof, the REIT purchases each participant's warehouse for a cash payment to the participant of an amount that is 70% to 80% of the appraised fair market value of the warehouse leaving a balance owed and issues a secured note payable to the participant for the balance owed, the secured note providing that the REIT will pay interest accruing on the balance owed to the participant in monthly installment payments and will pay the balance owed in full to the participant at the time the REIT obtains a new non-recourse mortgage loan for the warehouse, the secured note being secured by a second lien on the warehouse;
f) leasing each warehouse to the participant from whom the REIT purchased the warehouse, the leasing of each warehouse occurring when the REIT and each participant enter into the lease agreement, the lease agreement being a triple-net lease and comprising terms obligating the participant to pay rent to the REIT, the rent being established by a method comprising the steps of: i) determining an annual debt service amount for the non-recourse mortgage loan; ii) determining a total square footage of all the warehouses leased by the REIT; iii) dividing the annual debt service amount by the total square footage to derive a first component price per square foot; iv) adding to the first component a second component and a third component, the second component being an amount dedicated for use by the REIT to pay for general and administrative expenses of the REIT and the third component being an amount dedicated for use by the REIT as a working capital and to permit the REIT to make interest payments and cash distributions to each participant; the addition of the second and third component to the first component resulting in a formula rental price per square foot; and vi) multiplying the formula rental price per square foot by a square footage of the warehouse leased to the participant to derive an annual rent to be paid by the participant to the REIT;
g) issuing a non-recourse mortgage loan to the REIT, the non-recourse mortgage loan being issued by a lender for a loaned amount which is capable of financing the REIT's cash purchase of the warehouses, the non-recourse mortgage loan comprising terms obligating the REIT to make installment payments of principal and interest to the lender on the loaned amount, whereby the REIT uses the rent paid by the participants to make the installment payments;
h) employing a manager for the REIT, the manager being responsible for general and administrative operations of the REIT, the manager acquiring an ownership interest in the REIT, the REIT paying the manager an annual management fee in an amount that is the first component multiplied by the total square footage of all the warehouses;
i) transferring an ownership interest in the REIT to each participant;
j) reappraising each warehouse to determine a reappraised fair market value thereof and using the reappraised fair market value of each warehouse to calculate a total reappraised fair market value of all of the warehouses, the reappraising being conducted by at least one appraiser selected by a lender, the REIT paying for cost of appraising the warehouses;
k) renewing each lease agreement for an additional term of at least seven years;
l) issuing a new non-recourse mortgage loan to the REIT for a loaned amount that is 70% to 80% of the total reappraised fair market value of all of the warehouses, the new non-recourse mortgage loan being issued by a lender selected by the REIT, the new non-recourse mortgage loan providing proceeds to the REIT;
m) investing the proceeds provided by the new non-recourse mortgage loan in at least one investment capable of producing investment revenue; and
n) distributing at least 90% of net earnings from the investment revenue produced by the at least one investment to the participants.

26. The method according to claim 25, wherein the manager has a 1% ownership interest in the REIT and each participant's ownership interest in the REIT is a prorata share of a remaining 99% interest of the REIT, the prorata share being calculated by dividing the appraised fair market value of the participant's warehouse by a total appraised fair market value of all of the participants' warehouses.

27. The method according to claim 25, further comprising the step of the REIT purchasing and obtaining title to a leasehold improvement made by the participant to the warehouse leased to the participant, the REIT paying the participant an amount that is the participant's original cost for the leasehold improvement, the REIT's purchase of the leasehold improvement being accomplished at the time the lease agreement is renewed.

28. The method according to claim 25, further comprising the step of making an initial public offering of stock in the REIT on a stock exchange, the initial public offering being approved by a board of directors of the REIT.
